(19) United States
(12) Patent Application Publication
(10) Pub. No.: US 2006/0232880 A1
(43) Pub. Date: Oct. 19, 2006

(54) Mounting system for a storage media disc

(75) Inventors: Mo Xu, Singapore (SG); Poh Lye Lim, Singapore (SG); YiRen Hong, Singapore (SG)

Correspondence Address: SEAGATE TECHNOLOGY LLC C/O WESTMAN;CHAMPLIN & KELLY, P.A., SUITE 1400, 900 SECOND AVENUE SOUTH, MINNEAPOLIS, MN, 55402-3319, US

(73) Assignee: Seagate Technology LLC, Scotts Valley, CA (US)

(21) Appl. No.: 11/105,641

(22) Filed: Apr. 14, 2005

(51) Int. Cl. G11B 17/02

(52) U.S. Cl. 360/99.12

(57) ABSTRACT

A mounting system for a storage medium comprises a washer. The washer has a peripheral rim that is subject to a mounting distortion. The storage medium comprises a mounting rim facing the peripheral rim. The mounting rim is separated from the peripheral rim by an isolation space. Isolation material is disposed in the isolation space. The isolation material supports the storage medium on the washer. The isolation material deforms to relieve transmission of the mounting distortion to the mounting rim.

### FIELD OF THE INVENTION

The present invention relates generally to mounting of storage media, and more particularly but not by limitation to mounting of discs in a disc drive.

### BACKGROUND OF THE INVENTION

Disc drives are being developing with increased areal density of information storage on rotating disc surfaces. As the areal density increases, the fly height (spacing between a read/write head and the disc surface) needs to be increasingly smaller which, in turn, leads to a requirement for extreme flatness for the disc surface. Any imperfection in the flatness of the disc results in some loss of fly height, which increases the possibility that the read/write head can crash into the disc surface. A lack of flatness of the disc is the one of the main contributors in fly height loss. One main contributor to lack of flatness is distortion of the disc surface due to disc clamping forces applied directly at a center hub on the disc. Small mechanical imperfections in the clamping components lead to non-uniform clamping forces that distort the disc surface. Due to the non-uniform stress distribution, the disc hub (when clamped) distorts to follow the surface contour of the clamping components (such motor hub, disc clamp and spacer) at the place of contact and cause the imperfection in disc flatness near to the contacting zone. The imperfection in disc flatness will further extend from disc ID (inside diameter) to disc OD (outside diameter). This problem is further complicated by the variation of clamping forces due to normal temperature variations and differences in thermal expansion coefficients, referred to as a “thermal disc flatness problem”.

A method and apparatus are needed to provide mounting of discs in a disc drive with reduced distortion due to clamping forces. Embodiments of the present invention provide solutions to these and other problems, and offer other advantages over the prior art.

### SUMMARY OF THE INVENTION

Disclosed are a method and mounting system for mounting a storage medium. The mounting system comprises a washer. The washer has a peripheral rim that is subject to a mounting distortion.

The mounting system comprises a storage medium. The storage medium comprises a mounting rim facing the peripheral rim. The mounting rim is separated from the peripheral rim by an isolation space.

The mounting system comprises isolation material disposed in the isolation space. The isolation material supports the storage medium on the washer. The isolation material deforms to relieve transmission of the mounting distortion to the mounting rim.

Other features and benefits that characterize embodiments of the present invention will be apparent upon reading the following detailed description and review of the associated drawings.

### BRIEF DESCRIPTION OF THE DRAWINGS

FIG. 1 is an oblique view of a disc drive.

FIGS. 2A, 2B illustrate a first embodiment of a mounting system for a storage medium.

FIGS. 3A, 3B, 3C illustrate process steps in which an isolation material reduces distortion in a storage medium.

FIG. 4 illustrates stress relaxation in an isolation material.

FIG. 5 illustrates amplitude ranges of static stresses in an isolation material.

FIGS. 6A, 6B, 6C, 6D, 6E illustrate additional embodiments of mounting systems for a storage medium.

FIGS. 7-8 illustrate additional embodiments of mounting systems for multiple storage media.

FIGS. 9A-9B illustrate process steps in assembling a mounting system.

### DETAILED DESCRIPTION OF ILLUSTRATIVE EMBODIMENTS

In the field of storage media, requirements for non-operation mechanical shock are increasing, leading to requirements for higher clamping forces to withstand the shock without disturbing disc mounting concentricity. At the same time, increasingly thinner storage media discs are needed to fit into smaller form factor disc drives such as 1 inch drives. These thinner storage media discs are more easily distorted by clamping forces than the previous thicker discs. Thermal disc flatness problems are also greater with these thinner, more flexible discs.

Due to limitations of current manufacturing machining, grinding and stamping processes, it is very difficult from an economical standpoint to improve the flatness of the clamping components (such motor hub, disc clamp and spacer) to reduce clamping distortion. In current storage media designs, the clamping force is exerted directly on an inner rim of a disc, and any irregularity in the clamping surfaces tends to distort the surface of disc. Distortion of the flat surface of the disc leads to loss of fly height and head crashes.

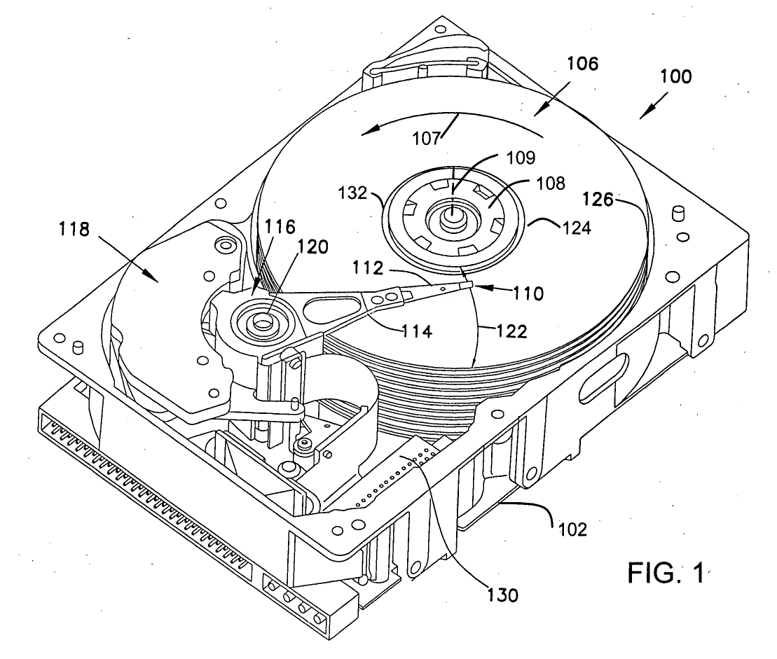

As described below in connection with FIGS. 1-8, an indirect mounting system of clamping is provided that includes isolation material between a clamping ring and a storage medium. The isolation material deforms to relieve transmission of distortion from the clamping ring to the storage medium surface. For example, as temperatures in the disc drive vary due to ambient temperature changes and warming up of the disc drive, the isolation material deforms to overcome thermal disc flatness problems. With the mounting system described below, the storage medium maintains its flatness and a low fly height over the operating temperature range, and high areal density can be achieved without danger of head crashes due to clamping distortion.

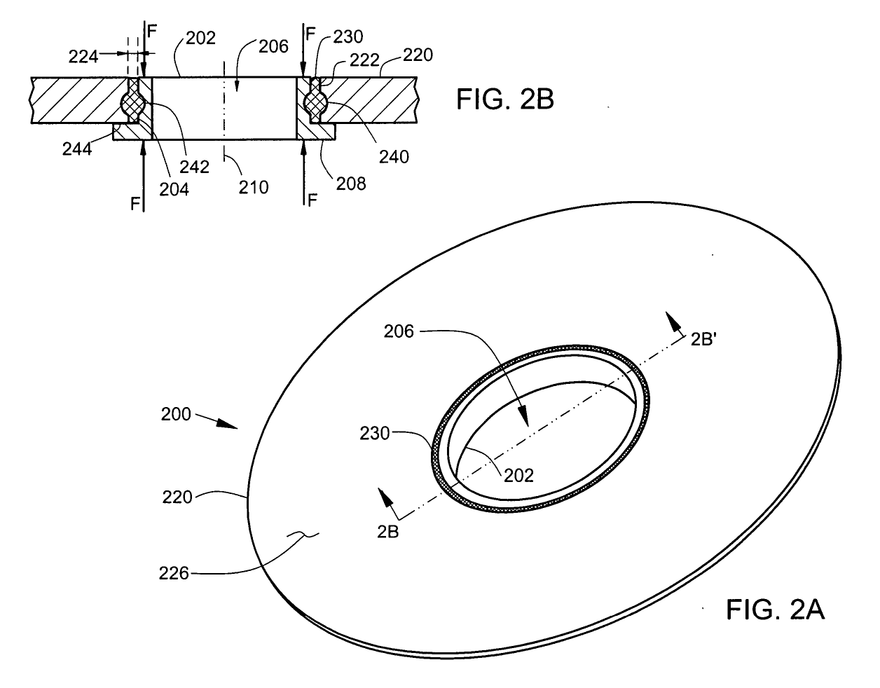

FIG. 1 is an oblique view of a disc drive 100 in which embodiments of the present invention are useful. Disc drive 100 includes a housing with a base 102 and a top cover (not shown). Disc drive 100 further includes a disc pack 106, which is indirectly mounted (clamped) on a spindle motor (not shown) by a disc clamp 108. Disc pack 106 includes one or more individual discs, which are mounted for co-rotation about central axis 109 in a direction 107. As described in more detail below in connection with FIGS. 2-8, the indirect method of clamping reduces distortion of disc surfaces. Each disc surface has an associated disc head slider 110 which is mounted to disc drive 100 for communication with the disc surface. The disc head slider 110 (also called a read/write head) flies over the disc surface at a fly height. The fly height can be greatly reduced because the individual discs are isolated by a ring of isolation material 132 and not distorted by clamping stresses.

In the example shown in FIG. 1, sliders 110 are supported by suspensions 112 which are in turn attached to track accessing arms 114 of an actuator 116. The actuator shown in FIG. 1 is of the type known as a rotary moving coil actuator and includes a voice coil motor (VCM), shown generally at 118. Voice coil motor 118 rotates actuator 116 with its attached heads 110 about a pivot shaft 120 to position heads 110 over a desired data track along an arcuate path 122 between a disc inner diameter 124 and a disc outer diameter 126. Voice coil motor 118 is driven by servo electronics 130 based on signals generated by heads 110 and a host computer (not shown).

FIG. 2A illustrates an oblique view of a first embodiment of a mounting system 200 for a storage media such as a disc. FIG. 2B illustrate a cross sectional view of the mounting system 200 along line 2B-2B′ in FIG. 2A. The mounting system 200 comprises a washer 202, also referred to as a disc holder. The washer 202 has a peripheral rim 204 that is subject to a mounting distortion. The term “mounting distortion” includes both non-uniformity of clamping forces and thermal changes in the clamping forces. The washer 202 has a hollow central bore 206 for mounting on a hub of a spindle motor (not shown). The washer 202 is preferably a shoulder washer with a generally “L” shaped cross-section that includes a small outwardly protruding rim 208. A disc clamp (not illustrated) presses down on the top of the washer 202 to clamp it to the hub of the spindle motor. The disc clamp exerts a clamping force “F” on the washer 202, and the clamping force produces the mounting distortion at the peripheral rim 204. This clamping force is not radially or circumferentially uniform and produces an asymmetric mounting distortion in the peripheral rim 204. The clamping force also typically varies with temperature. The washer 202 preferably has a generally cylindrical symmetry about a central axis of rotation 210. The washer 202 preferably comprises a metal or metal alloy compatible with disc drive construction.

The mounting system 200 also comprises a storage medium 220 that has a mounting rim 222 facing the peripheral rim 204. The mounting rim 222 is separated from the peripheral rim 204 by an isolation space 224. The storage medium 220 does not have a clamping force applied directly to it. The storage medium 220 can comprise a substrate of metal, ceramic or other known hard disc substrates. the storage medium 220 also comprises a surface layer or layers that are capable of storing or reproducing information when accessed by a read/write head.

The mounting system 200 also comprises isolation material 230 disposed between the mounting rim 222 and the peripheral rim 204 in the isolation space 224. The isolation material 230 radially and resiliently supports the storage medium 220 while the washer 202 axially supports the storage medium 220. The isolation material 230 deforms to relieve transmission of the mounting distortion to the mounting rim 222. The support provided by the isolation material 230 preferably provides an elastic support for smaller support forces and provides an inelastic, slowly creeping, relaxation support that relieves higher mounting distortion forces and reduces transmission of the higher mounting distortion forces to the storage media 220. The creeping relaxation can relieve changing forces to avoid thermal disc clamping problems. The isolation material creeps and conforms to the disc inside diameter (ID) when the disc ID changes size at different temperatures.

The storage medium 220 comprises a storage medium surface 226 and the deforming of the isolation material 230 reduces distortion of the storage medium surface 226. The storage medium 220 preferably comprises a hard disc, and the storage medium surface 226 preferably comprises a flat disc surface. The deforming of the isolation material 230 reduces distortion of the flat disc surface 226. The isolation material 230 deforms in an inelastic manner to relieve transmission of the distortion. The storage medium 220 is only indirectly mounted on the spindle motor via forces transmitted through the isolation material 230. The isolation material 230 transmits a support force between the storage medium 220 and the washer 202, and the isolation material 230 deforms in an elastic manner to the support force.

The isolation material 230 is preferably disposed in a continuous circle to comprises a ring of isolation material. In one preferred arrangement, the ring has an irregular side wall 240 that protrudes into the inner rim 222. In another preferred arrangement, the ring has an irregular side wall 242 that protrudes into the peripheral rim 204. One or both of protruding irregular sidewalls 240, 242 can be used to provide additional mounting support for a thicker, heavier disc.

In one preferred arrangement, the storage medium 220 rests on the protruding rim 208 to form a slip joint 244. The slip joint 244 has two smooth, sliding surfaces so that the storage medium 220 is free to move sideways relative to the washer 202. The slip joint 244 provides additional underside support for the storage medium 220 in case the mounting system 200 is dropped.

The isolation material 230 can comprise any material that provides the needed mechanical characteristics of an elastic range adequate for smaller support forces, and an inelastic range where stress relaxation can relieve larger mounting distortion forces. The isolation material 230 can comprise a temperature stable polymer, an ultraviolet (UV) cured epoxy resin, a silicone rubber, a thermosetting resin, a glass or a solder with the needed mechanical characteristics. The isolation material 230 also preferably has a temperature range compatible with a device storage temperature range, and low outgassing characteristics compatible with a storage device into which the mounting system 200 is integrated.

Clamping force by the clamping components is imposed on the disc holder (washer) 202 instead of storage medium 220. In order to increase the holding strength, the shapes of the peripheral rim 204 and the mounting rim 222 can be adjusted to improve the holding strength of the isolation material 230.

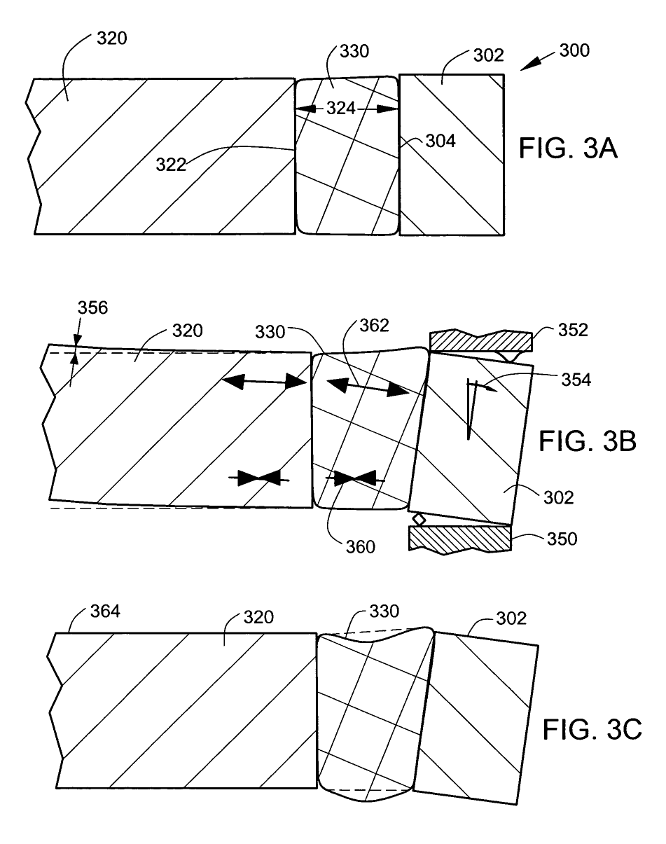

FIGS. 3A, 3B, 3C illustrate process steps in which an isolation material 330 reduces distortion in a storage medium 320. FIG. 3A illustrates a mounting system 300 in an undistorted condition before it is clamped. FIG. 3B illustrates the mounting system 300 in a distorted condition immediately after the mounting system 300 is clamped. FIG. 3C illustrates the mounting system 300 after the isolation material 330 has relaxed or changed shape to reduce transmission of distortion from a washer 302 to the storage medium 320.

As illustrated in FIG. 3A, the washer 302 is provided with a peripheral rim 304. The storage media has a mounting rim 322 facing the peripheral rim 304. The mounting rim 322 is separated from the peripheral rim 304 by an isolation space 324. The isolation space 324 is filled with the isolation material 330 to support the storage medium 320 on the washer 302.

As illustrated in FIG. 3B, the washer 302 is clamped between a spindle motor 350 and a disc clamp 352 that are slightly irregular, resulting in a mounting distortion indicated by rotation 354. The distortion is initially transmitted through the isolation material 330 to the mounting rim 322. As illustrated in FIG. 3B, the storage medium (typically a magnetic disc) 320 changes shape or distorts as indicated at 356. The transmitted distortion typically includes a complex field of compressive strains 360 and tensile strains 362.

As illustrated in FIG. 3C, the isolation material 330 slowly flows or changes shape to relieve the compressive and tensile strains 360, 362. The storage medium 320 is no longer subject to the distortion forces, and the storage medium returns to its original undistorted flat shape as indicated at 364.

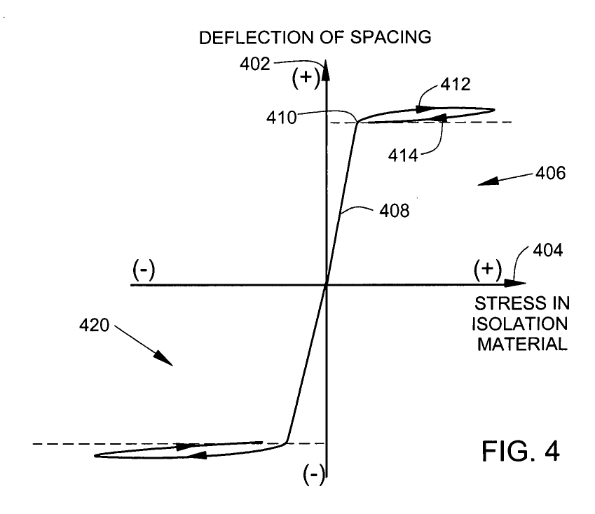

FIG. 4 illustrates stress relaxation in an isolation material. In FIG. 4, a vertical axis 402 represents a deflection (due to clamping distortion) acting on the isolation material. A zero deflection corresponds to a spacing (such as spacing 324 between rims 304, 322 in FIG. 3A) when there is no clamping distortion. The deflection results in a stress (force per unit area) acting in a region of an isolation material. The deflection can be compressive deflection (+) or tensile deflection (−). In FIG. 4, a horizontal axis 404 represents stress (force per unit area) in the direction of the deflection in the isolation material. The stress can be compressive stress (+) or tensile stress (−). A first curve 406 schematically indicates the compressive mechanical properties of a typical material suitable for use as an isolation material. The first curve 406 include a first straight line elastic portion 408 for lower levels of compressive deflection. In the first straight line elastic portion 408, when compressive deflection is increased and then decreased, the compressive stress also increases and decreases. If a mechanical deflection is applied to the isolation material (such as a clamping distortion) that increases compressive strain beyond a compressive elastic limit point 410, then the compressive stress goes up along line 412 and then the stress slowly creeps back along line 414 to relax or reduce at least a portion of the strain. The isolation material changes shape to accommodate the deflection. Corresponding processes occur for tensile deflections as indicated at curve 420.

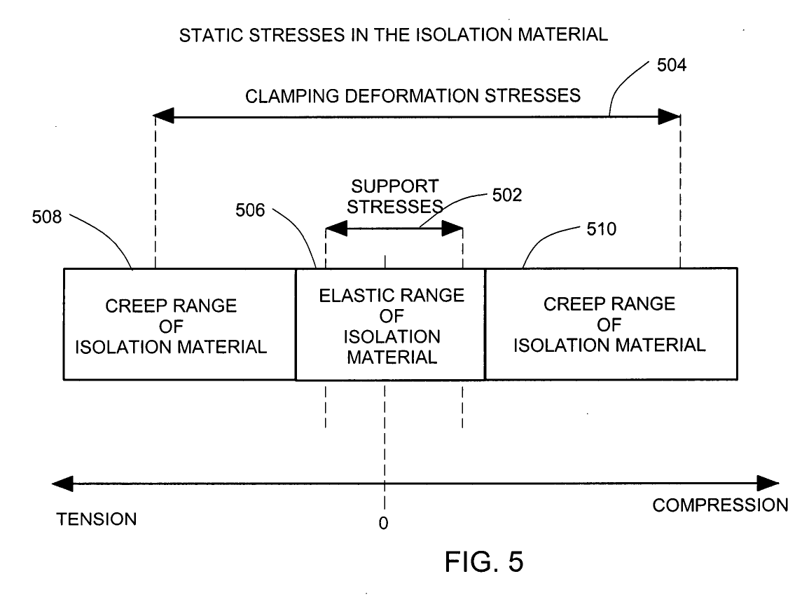

FIG. 5 illustrates amplitude ranges of static stresses in an isolation material. As schematically illustrated in FIG. 5, normal support stresses in isolation material, in other words the stresses that resist gravity and hold the disc in position are in a low range 502. Stresses in isolation material that are due to mounting distortion cover a wider range 504. An isolation material is selected that has an elastic mechanical range 506 that extends over the normal support stress range 502. The isolation material selected has creep properties over higher ranges 508, 510 that extend over the upper ranges of the mounting distortion range 504. The clamping deformation stress range 504 and the support stress range 502 can be scaled to the existing mechanical properties of a suitable isolation material by making adjustments to the length of the spacing (such as spacing 224 in FIG. 2) and the cross-sectional area of the isolation material that is transverse to the spacing. In this way, a useful combination of isolation material type and isolation material dimensions can be quickly arrived at with a limited number of trials. If desired, computer aided modeling can be used with a few experimental data points to reliably predict useful combinations for a particular application.

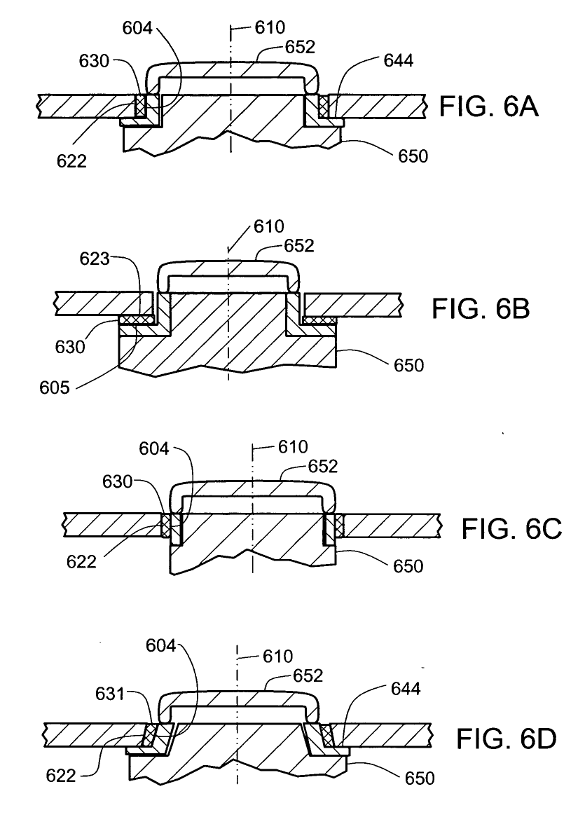

FIGS. 6A, 6B, 6C, 6D, 6E illustrate additional embodiments of mounting systems for a disc. In each of the embodiments illustrated in FIGS. 6A, 6B, 6C, 6D, 6E, a mounting system comparable to the mounting system 200 (FIGS. 2A-2B) is illustrated. In each of the embodiments illustrated in FIGS. 6A, 6B, 6C, 6D, 6E, isolation material 630, 631 is in the shape of a ring that has a generally quadrilateral cross-section. A disc clamp 652 clamps the washer to a spindle motor 650. In FIGS. 6A, 6B, 6C, the isolation material 630 has a generally rectangular cross section. In FIGS. 6D, 6E, the isolation material 631 has a generally rhomboid or parallelepiped cross section. In FIGS. 6A, 6D, a slip joint 644 is included. In FIGS. 6A, 6C, 6D, 6E, peripheral rims 604 and mounting rims 622 are approximately aligned parallel with a central axis 610. In FIG. 6B, a peripheral rim 605 and a mounting rim 623 are approximately aligned perpendicular with a central axis 610. The various geometries shown in FIGS. 6A, 6B, 6C, 6D, 6E provide the designer with various embodiments to simplify adjustment of spacing and cross-sectional areas of the isolation material in order to place the mounting stresses in an elastic range of the isolation material and to place the higher ranges of distortion stresses in the creep range of the isolation material.

In each of the embodiments shown in FIGS. 6A, 6B, 6C, 6D, 6E, a mounting system includes a washer, a storage medium and isolation material that operate in a manner comparable to the embodiment shown in FIGS. 2A-2b. Features described in connection with FIGS. 2A, 2B can be appropriately adapted to the embodiments illustrated in FIGS. 6A, 6B, 6C, 6D, 6E.

There is no effective direct strain coupling between the disc and the clamping components.

In FIGS. 6D, 6E, tapered washers are provided for easy installation and radial alignment on a tapered spindle motor hub.

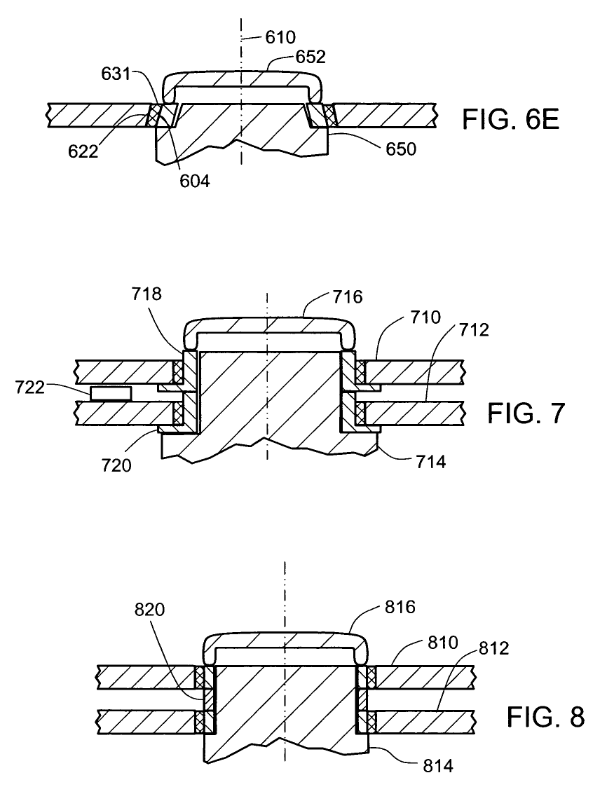

FIGS. 7-8 illustrate additional embodiments in which multiple mounting systems 710, 712, 810, 812 (such as those described above in connection with FIGS. 2A, 2B, 6A, 6B, 6C) are clamped on a spindle motor 714, 814 with a disc clamp 716, 816. The multiple mounting systems 710, 712 or 810, 812 are stacked. In the embodiment illustrated in FIG. 7, shoulder washers 718, 720 have sufficient axial thickness to provide needed access space for movement of a read/write head 722 between mounting systems 710, 712. In the embodiment illustrated in FIG. 8, a spacer ring 820 is used to provide needed access space for read/write head movement between mounting systems 810, 812.

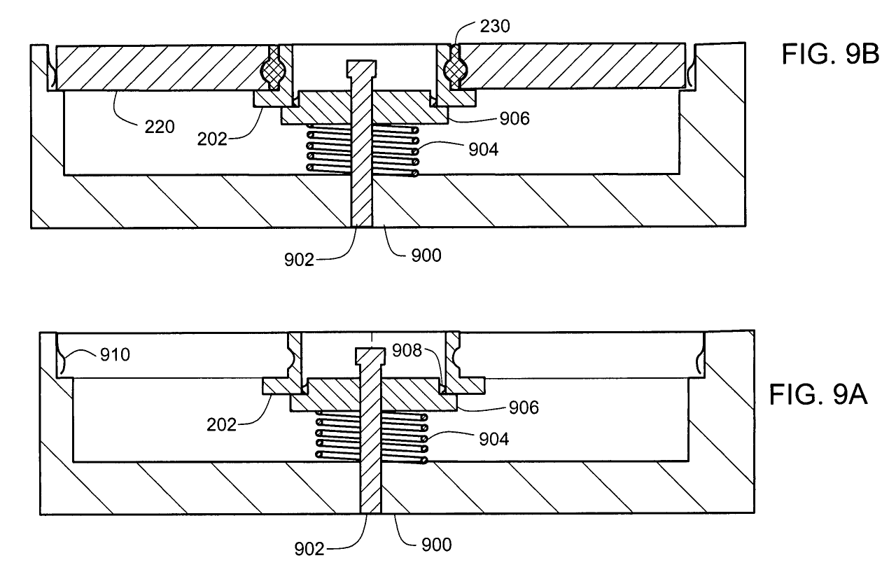

FIGS. 9A-9B illustrate process steps in assembling a mounting system such as mounting system 200 illustrated in FIGS. 2A-2B. As illustrated in FIG. 9A, an assembly fixture includes a cylindrical cup-shaped fixture body 900 in which a central axial round pin 902 is mounted. A hub 906 is mounted on the axial pin 902 and is free to slide. A coil spring 904 is arranged around the axial pin 902 and exerts a lift force on the hub 904. The lift force is sufficient to lift a weight of the hub 906 and a washer 202, but the lift force is not sufficient to lift an additional weight of a storage medium disc 220. The hub 904 has an outer shoulder for receiving and supporting the washer 202, and the shoulder is provided with a first annular arrangement of spring fingers 908 that precisely center the washer 202 on the shoulder of hub 906. The washer 202 is thus precisely centered relative to a second annular arrangement of spring fingers 910 mounted on the cup shaped body 900. In FIG. 9A, the washer 202 is first placed on the hub 906 and then in FIG. 9B the storage medium disc 220 is placed on the washer 202. The storage medium disc 202 is precisely centered by the second annular arrangement of spring fingers 910. A properly aligned annular isolation space 224 (FIG. 2A) is formed between the washer 202 and the disc 220. A liquid isolation material is poured in the isolation space 224 and cured to form a cured-in-place isolation ring 230. After curing the assembly of disc 220, isolation ring 230 and washer 202 is removed from the assembly fixture and installed in a disc drive (such as disc drive 100 in FIG. 1.

The isolation ring 230 is cured-in-place to provide a high bond strength in bonding to the disc and the washer in order to withstand non-operating shock without separation of the bond. The isolation material also has the advantage of providing vibration isolation and damping to the disc during mechanical shock events. The isolation material can comprises a thermally stable polymer. The thermally stable polymer can comprise epoxy resin, which may include fillers and plasticizers. The thermally stable polymer can also comprise silicone rubber, or other adhesives. A large variety of thermally stable polymers are commercially available. The mechanical dimensions of a disc inner rim, a washer peripheral rim, and an isolation material thickness can be adjusted to optimize isolation of clamping stresses while providing mounting stability for a selected isolation material type. Glasses and solders that have creep relaxation characteristics can also be used for the isolation material.

The mounting system presently described reduces transmission of imperfection in flatness of the clamping components (such motor hub, disc clamp and spacer) to the disc surface. With the mounting system described herein, there is no direct distortion coupling between the clamping components and the disc. The flatness of the disc will be largely independent of clamping imperfections and mounted disc flatness will be close to the flatness of an unmounted disc.

The mounting system as presently described is compatible with existing motor hubs and disc clamps. The profile of the motor hub and the profile of the disc clamp can be similar to that of a conventional design. The disc clamp can be a one screw clamp or multiple screw clamp or even a clamp without screws.

If desired, an alignment fixture can be used to concentrically align the disc and the washer when the isolation material is cured in place. The alignment fixture can also be used to set an axial spacing between the disc and the washer to control a thickness of the isolation material. The isolation material is preferably applied as a liquid, and allowed to set to form bonds with contacting surfaces. In a preferred arrangement, the isolation material is applied and allowed to set before the assembled disc, isolation material and washer are assembled into a disc drive. This reduces the cycle time for the disc drive assembly process. If a disc is found to be defective after installation in a disc drive, the assembled disc, isolation material and washer can be removed as an assembly and replaced with a substitute. Isolation materials can include ultraviolet (UV) cured epoxies, thermosetting resins, solvent based adhesives, or other suitable temperature stable polymer-based material.

The disclosed mounting system can be used in a disc drives over a complete range of form factor sizes and with discs having a complete range of disc thicknesses. The mounting system is scalable to match a particular disc drive design without losing the benefits of the mounting isolation.

The isolation material behaves like a buffer zone and tends to smoothen out the stress and stress concentration introduced by the clamping and the imperfection in clamping component flatness. Since no clamping force is imposed directly onto the disc or the isolation material, the imperfection in disc flatness due to the clamping and clamping component flatness will be very low. The disc assembly flatness will be very near to the disc flatness at component level.

The washer can be produced by means of machining or grinding or both. The material for the washer can comprise metal such as steel, aluminum, brass and other metals. The isolation material is preferably free of particle contamination and with low outgassing characteristics suitable for use in a hard disc drive application. An epoxy resin is preferred with proper hardness (after curing) so that it will not cause stress concentration on the disc or transfer stress concentration to the disc from the clamping components (such as motor hub, spacer and disc clamp). The isolation material smoothens out stress concentrations on the clamping ring due to the poor flatness of the clamping components, such as motor hub and disc clamp.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the mounting system while maintaining substantially the same functionality without departing from the scope of the present invention. In addition, although the preferred embodiment described herein is directed to a mounting for use in a disc drive, it will be appreciated by those skilled in the art that the teachings of the present invention can be applied to mounting other types of storage media to avoid distortion of a flat media surface, without departing from the scope of the present invention.

1. A mounting system for a storage medium, comprising:
a washer having a peripheral rim that is subject to a mounting distortion;
a storage medium having a mounting rim facing the peripheral rim, the mounting rim being separated from the peripheral rim by an isolation space; and
isolation material disposed in the isolation space to support the storage medium on the washer, and the isolation material comprising a cured-in-place material that forms bonds with contacting surfaces of the mounting rim and the peripheral rim, and the isolation material deforming to relieve transmission of the mounting distortion to the mounting rim.

2. The mounting system of claim 1 wherein the storage medium comprises a storage medium surface and the deforming of the isolation material reduces distortion of the storage medium surface.

3. The mounting system of claim 1 wherein the storage medium comprises a hard disc with a flat disc surface and the deforming of the isolation material reduces distortion of the flat disc surface.

4. The mounting system of claim 1 wherein the isolation material deforms in an inelastic manner to relieve transmission of distortion.

5. The mounting system of claim 1 wherein the isolation material comprises a stress relaxation material.

6. The mounting system of claim 1 wherein the isolation material transmits a support force between the storage medium and the washer, and the isolation material deforms in an elastic manner to the support force.

7. The mounting system of claim 1 wherein the isolation material comprises a ring.

8. The mounting system of claim 7 wherein the ring has an irregular side wall that protrudes into the inner mounting rim.

9. The mounting system of claim 7 wherein the ring has an irregular side wall that protrudes into the peripheral rim.

10. The mounting system of claim 7 wherein the washer comprises a shoulder washer.

11. The mounting system of claim 10, and further comprising a slip joint between the shoulder washer and the storage medium.

12. The mounting system of claim 1 wherein the storage medium is free of thermal disc flatness variation.

13. A mounting system for a storage medium, comprising:
a washer having a peripheral rim that is subject to a mounting distortion; and a storage medium having a mounting rim facing the peripheral rim, the mounting rim being separated from the peripheral rim by an isolation space; and
isolation means disposed in the isolation space to support the storage medium on the washer, and the isolation material deforming to relieve transmission of the mounting distortion to the mounting rim, the isolation material comprising a cured-in-place material that forms bonds with contacting surfaces of the mounting rim and the peripheral rim.

14. The mounting system of claim 13 wherein the storage medium comprises a hard disc with a flat disc surface and the deforming of the isolation means reduces distortion of the flat disc surface.

15. The mounting system of claim 13 where in the isolation means deforms in an inelastic manner to relieve transmission of the distortion.

16. The mounting system of claim 13 wherein the isolation means comprises a stress relaxation material.

17. A method of mounting a storage medium, comprising:
providing a washer having a peripheral rim that is subject to a mounting distortion;
disposing a mounting rim of the storage medium to face the peripheral rim;
separating the mounting rim from the peripheral rim by an isolation space;
filling the isolation space with isolation material to support the storage medium on the washer, and to relieve transmission of the mounting distortion to the mounting rim; and
forming the isolation material of a cured-in-place material that forms bonds with contacting surfaces of the mounting rim and the peripheral rim.

18. The method of claim 17 wherein the storage medium comprises a hard disc with a flat disc surface, and the isolation material deforms to reduce distortion of the flat disc surface.

19. The method of claim 17 where in the isolation material deforms in an inelastic manner to relieve transmission of the distortion.

20. The mounting system of claim 17 wherein the isolation material stress relaxes to relieve the mounting distortion.
